(19) United States
(12) Patent Application Publication
(10) Pub. No.: US 2026/0012825 A1
(43) Pub. Date: Jan. 8, 2026

(54) CHANNEL INFORMATION DETERMINATION METHOD AND APPARATUS, AND MEDIUM

(71) Applicants: GUANGDONG OPPO MOBILE TELECOMMUNICATIONS CORP., LTD., Dongguan (CN); TSINGHUA UNIVERSITY, Beijing (CN)

(72) Inventors: Yuan SHEN, Dongguan (CN); Jiawei ZHANG, Dongguan (CN); Yang LIU, Dongguan (CN); Xinlei YU, Dongguan (CN); Qianxi LU, Dongguan (CN); Cong SHI, Dongguan (CN)

(21) Appl. No.: 19/327,073

(22) Filed: Sep. 12, 2025

Related U.S. Application Data
(63) Continuation of application No. PCT/CN2023/086280, filed on Apr. 4, 2023.

(51) Int. Cl. H04W 24/08

(52) U.S. Cl. CPC H04W 24/08

(57) ABSTRACT

A channel information determination method and apparatus, and a medium are provided. The method includes: inputting a first sampling result and set parameter information into a trained first decoder, so that the trained first decoder outputs first channel information corresponding to the set parameter information, wherein the first sampling result is determined by means of sampling a first probability distribution of a hidden variable, which is output by a trained first encoder.

### CROSS-REFERENCE TO RELATED APPLICATION

This application is a continuation of International Patent Application No. PCT/CN2023/086280 filed on Apr. 4, 2023, the disclosure of which is hereby incorporated by reference in its entirety.

### BACKGROUND

In the related art, it is necessary to manually collect a large amount of parameter information and channel information corresponding to each piece of parameter information. However, manually collecting the large amount of parameter information and the corresponding channel information is inefficient.

### SUMMARY

The embodiments of the disclosure relate to the technical field of communication, and provide a method and apparatus for channel information determination, a medium, a chip, a product and a program.

In a first aspect, an embodiment of the disclosure provides a method for channel information determination, and the method includes the following operation. A first sampling result and set parameter information are input into a trained first decoder, such that the trained first decoder outputs first channel information corresponding to the set parameter information. The first sampling result is determined by sampling a first probability distribution of a hidden variable output by a trained first encoder.

In a third aspect, an embodiment of the disclosure provides an electronic apparatus, and the electronic apparatus includes a processor and a memory. The memory is used to store a computer program. The processor is configured to invoke and run the computer program stored in the memory to cause the electronic apparatus to perform a method, the method including: inputting a first sampling result and set parameter information into a trained first decoder, such that the trained first decoder outputs first channel information corresponding to the set parameter information; wherein the first sampling result is determined by sampling a first probability distribution of a hidden variable output by a trained first encoder.

In a fourth aspect, an embodiment of the disclosure provides a computer storage medium storing one or more programs. The one or more programs are executable by one or more processors to implement a method, the method including: inputting a first sampling result and set parameter information into a trained first decoder, such that the trained first decoder outputs first channel information corresponding to the set parameter information; wherein the first sampling result is determined by sampling a first probability distribution of a hidden variable output by a trained first encoder.

### BRIEF DESCRIPTION OF THE DRAWINGS

The accompanying drawings illustrated herein are intended to provide a further understanding of the disclosure and form part of the disclosure. The schematic embodiments of the disclosure and their description are intended to explain the disclosure, and do not constitute an unduly limiting of the disclosure. In the accompanying drawings:

FIG. 1 is a schematic diagram of an application scenario according to an embodiment of the disclosure.

FIG. 2 is a structural schematic diagram of a GAN in the related art.

FIG. 3 is a schematic flowchart of a method for channel information determination provided in an embodiment of the disclosure.

FIG. 4 is a schematic flowchart of another method for channel information determination provided in an embodiment of the disclosure.

FIG. 5 is a schematic flowchart of yet another method for channel information determination provided in an embodiment of the disclosure.

FIG. 6 is a schematic flowchart of still yet another method for channel information determination provided in an embodiment of the disclosure.

FIG. 7 is a schematic flowchart of a method for channel information determination provided in another embodiment of the disclosure.

FIG. 8 is a schematic flowchart of a method for channel information determination provided in yet another embodiment of the disclosure.

FIG. 9 is a schematic diagram of sending and receiving of a signal provided in an embodiment of the disclosure.

FIG. 10 is a schematic diagram of a training process of an encoder-decoder to be trained provided in an embodiment of the disclosure.

FIG. 11 is a schematic diagram of a generation process of first channel information provided in an embodiment of the disclosure.

FIG. 12 is a schematic diagram of a system architecture provided in an embodiment of the disclosure.

FIG. 13 is a schematic diagram of a compositional structure of an electronic apparatus provided in an embodiment of the disclosure.

FIG. 14 is a schematic diagram of a compositional structure of another electronic apparatus provided in an embodiment of the disclosure.

FIG. 15 is a schematic structural diagram of a chip according to an embodiment of the disclosure.

### DETAILED DESCRIPTION

The technical solutions in the embodiments of the disclosure will be described below with reference to the accompanying drawings in the embodiments of the disclosure. It will be apparent that the described embodiments herein are only part of but not all of the embodiments in the disclosure. Based on the embodiments in the disclosure, all other embodiments obtained by those of ordinary skilled in the art without making any creative effort fall within the scope of protection of the disclosure.

The technical solutions recorded in the embodiments of the disclosure may be combined arbitrarily without conflict. In the description of the disclosure, unless otherwise explicitly and specifically defined, the term “multiple” means “two or more”.

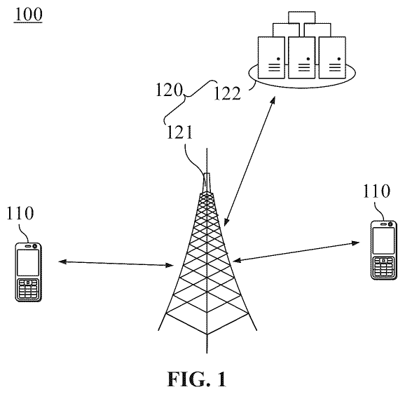

FIG. 1 is a schematic diagram of an application scenario according to an embodiment of the disclosure. As illustrated in FIG. 1, a communication system 100 may include a terminal device 110 and a network device 120. The network device 120 may communicate with the terminal device 110 via an air interface. Multi-service transmission is supported between the terminal device 110 and the network device 120.

It should be understood that the embodiment of the disclosure illustrates only the communication system 100, but the embodiments of the disclosure are not limited thereto. That is to say, the technical solutions in the embodiments of the disclosure can be applied to various communication systems, such as: global system of mobile communication (GSM) system, code division multiple access (CDMA) system, wideband code division multiple access (WCDMA) system, general packet radio service (GPRS), long term evolution (LTE) system, advanced long term evolution (LTE-A) system, new radio (NR) system, evolution of NR system, LTE-based access to unlicensed spectrum (LTE-U) system, NR-based access to unlicensed spectrum (NR-U) system, universal mobile telecommunication system (UMTS), wireless local area networks (WLAN), wireless fidelity (Wi-Fi), LTE time division duplex (TDD), Internet of Things (IoT) system, narrow band Internet of Things (NB-IoT) System, enhanced machine-type communications (eMTC) system, or future communication systems (e.g., 6G communication system, 7G communication system), etc.

The network device 120 in the embodiments of the disclosure may include an access network device 121 and/or a core network device 122. The access network device may provide communication coverage for a particular geographic area and may communicate with the terminal device 110 (e.g., UE) within that coverage area.

The terminal device in any of embodiments of the disclosure may be a device with wireless communication capabilities, and may be deployed on land, including indoor or outdoor, handheld or vehicle-mounted. The terminal device may also be deployed on the water (such as ships, etc.). The terminal device may also be deployed in the air (e.g. on aircraft, balloons and satellites, etc.). The terminal device in any of embodiments of the disclosure may be referred to as a user equipment (UE), a mobile station (MS), a mobile terminal (MT), a subscriber unit, a subscriber station, a mobile station, a remote station, a remote terminal, a mobile device, a user terminal, a terminal, a wireless communication device, a user agent or a user device. The terminal device in any of embodiments of the disclosure may include one of or a combination of at least two of: a server, a neural network device, an Internet of Things (IoT) device, a satellite terminal, a wireless local loop(WLL) station, a personal digital assistant (PDA), a handheld device with wireless communication capabilities, a computing device or another processing device connected to a wireless modem, a server, a mobile phone, a pad, a computer with wireless transceiver capabilities, a handheld computer, a desktop computer, a portable media player, a smart speaker, a navigation device, wearable devices such as a smart watch, smart glasses, a smart necklace, a pedometer, a digital TV, a virtual reality (VR) terminal device, an augmented reality (AR) terminal device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or vehicles, an in-vehicle device, an in-vehicle module, a wireless modem, a handheld, a customer premise equipment (CPE), smart home appliances and the like in a vehicle-to-everything system.

Optionally, the terminal device may be any terminal device including, but not limited to, a terminal device connected to the network device or other terminal devices via wired or wireless connections.

Optionally, the terminal device may be used for device to device (D2D) communication.

In any of embodiments of the disclosure, the access network device may include one of or a combination of at least two of: an evolutional node B (eNB or eNodeB) in an long term evolution (LTE) system, a next generation radio access network (NG RAN) device, a base station (gNB) in an NR system, a small station, a micro station, a wireless controller in a cloud radio access network (CRAN), a wireless-fidelity (Wi-Fi) access point, a transmission reception point (TRP), a relay station, an access point, an in-vehicle device, a wearable device, a hub, a switch, a bridge, a router, or a network device in a future evolved public land mobile network (PLMN), etc.

In any of embodiments of the disclosure, the core network device may be a 5th generation (5G) core network (5GC) device, and the core network device may include one of or a combination of at least two of: a sensing function (SF), an access and mobility management function (AMF), an authentication server function (AUSF), a user plane function (UPF), a session management function (SMF), a location management function (LMF), or a policy control function (PCF). In other implementations, the core network device may also be an evolved packet core(EPC) device of an LTE network, such as a session management function+core packet gateway (SMF+PGW-C) device. It is to be understood that the SMF+PGW-C may simultaneously implement functions that can be achieved by both the SMF and the PGW-C. In the process of network evolution, the above-mentioned core network device may also be called by other names, or a new network entity may be formed by performing partition on the functions of the core network, which is not limited in the embodiments of the disclosure.

The various functional units in the communication system may also establish a connection between each other via a next generation (NG) network interface to achieve communication.

For example, the terminal device establishes an air interface connection with the access network device via the NR interface, for the transmission of user plane data and control plane signaling. The terminal device may establish a control plane signaling connection with the AMF via the NG interface 1 (N1 for short). The access network device, such as the next generation radio access base station (gNB), may establish a user plane data connection with the UPF via the NG interface 3 (N3 for short). The access network device may establish a control plane signaling connection with the AMF via the NG interface 2 (N2 for short). The UPF may establish a control plane signaling connection with the SMF via the NG interface 4 (N4 for short). The UPF may interact user plane data with the data network via the NG interface 6 (N6 for short). The AMF may establish a control plane signaling connection with the SMF via the NG interface 11 (N11 for short). The SMF may establish a control plane signaling connection with the PCF via the NG interface 7 (N7 for short).

FIG. 1 exemplifies one base station, one core network device, and two terminal devices. Optionally, the wireless communication system 100 may include multiple base station devices, and the coverage of each base station may include another number of terminal devices, which is not limited in the embodiments of the disclosure.

It is to be noted that, FIG. 1 illustrates, by way of example only, the system to which the disclosure is applicable, although the method illustrated in the embodiments of the disclosure may also be applied to other systems. Furthermore, in this context, the terms “system” and “network” are generally used interchangeably herein. In this context, the term “and/or” merely indicates an association relationship for describing associated objects, and represents that there are three kinds of relationships. For example, “A and/or B” may represent three situations, i.e., independent existence of A, existence of both A and B, and independent existence of B. In addition, in this context, the character “/” generally indicates that the anterior and posterior associated objects are in a kind of “or” relationship. It is also to be understood that “indicate/indication” mentioned in the embodiments of the disclosure may be a direct indication, or may be an indirect indication, or may represent that there is an association relationship. For example, A indicates B, which may represent that A indicates B directly, for example, B may be acquired through A; or, may represent A indicate B indirectly, for example, A indicates C, and B may be acquired through C; or may represent that there is an association relationship between A and B. It is also to be understood that “correspond/correspondence” mentioned in the embodiments of the disclosure may represent that there is a direct or indirect correspondence between the two objects; or, may represent that there is an association relationship between two objects; or, may be a relationship such as indicating and being indicated, configuring and being configured, etc. It is also to be understood that “predefined/predefinition”, “agreed upon in a protocol”, “predetermined” or “predefined rule” mentioned in the embodiments of the disclosure may be implemented by storing corresponding codes, tables, or other means which may be used to indicate relevant information in advance within a device (including, for example, a terminal device and a network device), the specific implementation thereof are not be limited in the disclosure. For example, “predefined” may be “defined in a protocol”. It is also to be understood that, in an embodiment of the disclosure, the “protocol” may be a standard protocol in the field of communications, and for example, it may include an LTE protocol, an NR protocol, and relevant protocols applied to future communication systems, which are not limited in the disclosure.

In some embodiments, positioning may be performed based on detectable wireless signals, such as communication signals, ultra wide band (UWB) signals, wireless fidelity (Wi-Fi) signals, or Bluetooth signals, etc. Optionally, in any of embodiments of the disclosure, the positioning may include indoor positioning and/or outdoor positioning, etc. There are two main positioning methods based on machine learning, namely the positioning method based on traditional machine learning and the positioning method based on deep learning.

The general flow of the positioning method based on traditional machine learning is as follows: data collection→feature extraction →algorithms such as support vector machine (SVM) or K-nearest neighbor (KNN)→location estimation. The positioning method based on traditional machine learning requires manual feature extraction. However, for high-dimensional inputs, it is challenging to design efficient and reliable features that cannot be automatically generalized to new task scenarios using different radio frequency signals, thereby affecting positioning accuracy.

Compared with the positioning method based on traditional machine learning, the positioning method based on deep learning may extract reliable features from data and is more suitable for processing high-dimensional data. Due to the fact that the channel state information (CSI) of the 5G multiple-input multiple-output (MIMO)-orthogonal frequency division multiplexing (OFDM) system may provide the phase and amplitude information of multi-channel subcarriers, describe the fine-grained features of the channel, and better describe the propagation path of the signal, using high-dimensional CSI as data is suitable for the positioning method based on deep learning. The positioning method provided in an embodiment of the disclosure is the positioning method based on deep learning.

One main problem of the positioning method based on deep learning is the requirement for collecting a large amount of accurately labeled data (that is, a large amount of parameter information and channel information corresponding to each piece of parameter information), which poses significant challenges in data set construction and incurs high labor costs. If the amount of collected data is insufficient, it will affect the positioning accuracy. There are two common solutions, namely: 1) performing signal processing on the collected signals to achieve the effect of data enhancement; 2) conducting data enhancement through a generator model.

Performing signal processing on the collected signal includes at least one of the operations of: adding white noise under different signal-to-noise ratios, introducing phase ambiguity, or superimposing data in various situations. For example, to improve robustness, white noise under different signal-to-noise ratios will be introduced into the data to enhance the data. For example, to improve the angular resolution, phase offset will be introduced into the data set, angular increment or decrement will be introduced into the original data, and the regression label will be enriched on the premise of maintaining the ratio of the original data to the synthetic data. For example, to obtain multi-source data, the collected single-source data will be superimposed to construct the multi-source data, so as to enrich the training data.

The data enhancement method based on the generator model may learn and train on the collected signals by using the generator model, and learn the real data distribution of the training set. Consequently, the model may generate some fake data to enrich the data set. The data enhancement method based on the generator model in the related art employs a generator model based on a generative adversarial network (GAN). In the embodiments of the disclosure, the decoder in the encoder-decoder is regarded as the corresponding generator model.

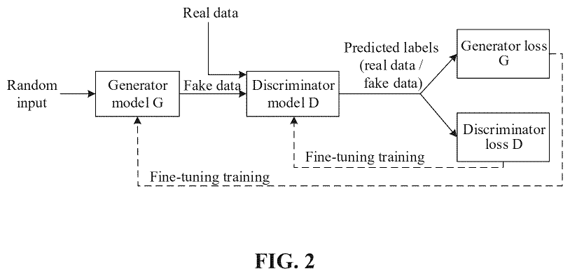

FIG. 2 is a structural schematic diagram of a GAN in the related art. As illustrated in FIG. 2, the GAN includes two parts: a generator model G (also known as the generator) and a discriminator model D (also known as the discriminator). The generator model G receives random input (also known as random noise) and outputs fake data. The discriminator model D receives the fake data and real data and outputs predicted labels. The predicted labels include two categories: the real data and the fake data. The generator model G undergoes fine-tuning training through the predicted labels and a generator loss G (Loss_G). The discriminator model D undergoes fine-tuning training through the predicted labels and a discriminator loss D (Loss_D). In this way, the generator model G takes random noise as input and learns how to produce a real output representation similar to the real data. The discriminator model D learns how to distinguish between false samples and real samples. The two models are trained together until the generator model G is able to generate real samples from the input noise.

The signal processing method for collected signals has some problems, such as complicated data processing and limited performance improvement. For example, the following method is proposed in the related art. Taking the covariance matrix of the signal as input data, FC-DeepAoANet and CNN-DeepAoANet pair is designed for test scenario classification and angle estimation. The data enhancement is achieved by introducing white noise under different signal-to-noise ratios and appropriate phase ambiguity into the collected data, as well as by superimposing the collected single-source data to construct multi-source data. However, this requires introducing noise with different signal-to-noise ratios for each type of data and introducing appropriate phase ambiguity, and also requires synthesizing data sets in various situations, which leads to complicated data processing and limited performance improvement.

The method of GAN-based generator model has the problem that it requires estimating the fake labels of the generated data, which may introduce errors. For example, in the related art, the positioning method for data enhancement based on data generated by the GAN-based generator model is proposed. The method generates fake data based on a small part of truly collected labeled data. However, the data generated in this way is not labeled, and another model needs to be designed to estimate the fake labels of the generated data. There will be errors in estimating the labels of the generated data, which will further introduce positioning errors.

For convenience of understanding of technical solutions in the embodiments of the disclosure, the technical solutions in the disclosure are described in detail by way of specific embodiments hereinafter. The solution in any one or more of the above embodiments, as alternatives, may be arbitrarily combined with the technical solutions in the embodiments of the disclosure, all of which belong to the scope of protection of the embodiments of the disclosure. The embodiments of the disclosure include at least some of the following contents.

Optionally, in any of embodiments of the disclosure, the electronic apparatus may include any apparatus with information processing function. For example, the electronic apparatus may be one of or a combination of at least two of: a neural network processing unit (NPU), a central processing unit (CPU), a graphics processing unit (GPU), a tensor processing unit (TPU), a deep learning processing unit (DPU), or a brain processing unit (BPU). Alternatively, the electronic apparatus may be an apparatus including one of or a combination of at least two of the above units.

Optionally, in any of embodiments of the disclosure, the electronic apparatus may be included in an electronic device, or the electronic apparatus may be applied in an electronic device.

Optionally, in some embodiments, the electronic apparatus may be an electronic device. In any of embodiments of the disclosure, at least one of the electronic device, the first device, the second device, or the third device may include one of: a terminal device, an access network device, or a core network device.

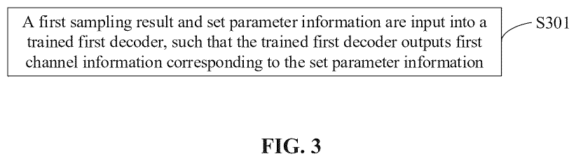

FIG. 3 is a schematic flowchart of a method for channel information determination provided in an embodiment of the disclosure. As illustrated in FIG. 3, the method is applied in an electronic apparatus and includes the following operation.

In operation S301, a first sampling result and set parameter information are input into a trained first decoder, such that the trained first decoder outputs first channel information corresponding to the set parameter information.

The first sampling result is determined by sampling a first probability distribution of a hidden variable output by a trained first encoder.

Optionally, the trained first decoder and/or the trained first encoder may be stored in the electronic apparatus. Optionally, the trained first decoder and/or the trained first encoder may be locally trained by the electronic apparatus, or may be trained by the first device and sent by the first device to the electronic apparatus.

Optionally, the first sampling result may be referred to as a first hidden variable obtained through sampling. Optionally, the following second sampling result may be referred to as a second hidden variable obtained through sampling. Optionally, the following third sampling result may be referred to as a third hidden variable obtained through sampling.

Optionally, the set parameter information may be the parameter information after the first preprocessing. Optionally, the parameter information before the first preprocessing cannot be directly input into the trained first decoder. The electronic apparatus may preprocess the parameter information before the first preprocessing to obtain the parameter information after the first preprocessing, that is, the set parameter information.

Optionally, the set parameter information may include one or more pieces of set parameter information. Optionally, in any of embodiments of the disclosure, the parameters corresponding to different pieces of parameter information among the one or more pieces of parameter information may be the same or different or partially the same. For example, the first parameter information includes distance information between the signal sending device and the signal receiving device, the second parameter information includes angle information between the signal sending device and the signal receiving device, and the third parameter information includes the distance information between the signal sending device and the signal receiving device, as well as the angle information between the signal sending device and the signal receiving device.

Optionally, the set parameter information may be parameter information randomly generated by the electronic apparatus, or may be parameter information input by the user to the electronic apparatus, or may be parameter information set in advance, or may be parameter information received by the electronic apparatus from the second device. Optionally, the one or more pieces of parameter information in the set parameter information may partially overlap or have no overlap with the one or more pieces of parameter information in the parameter information of the received signal.

Optionally, the first channel information corresponding to the set parameter information may include each piece of first channel information that corresponds one-to-one with each piece of parameter information in the set parameter information. Optionally, the one or more piece of parameter information may correspond one-to-one with one or more piece of first channel information. Optionally, different pieces of parameter information may correspond to different pieces of first channel information.

Optionally, in some embodiments, at least one of the first probability distribution, the second probability distribution described below, or the third probability distribution described below may be a Gaussian distribution. In other embodiments, at least one of the first probability distribution, the second probability distribution, or the third probability distribution may be another distribution which, for example, may include one of: a uniform distribution, a Bernoulli distribution, a Laplace distribution, a Poisson distribution, an exponential distribution, or a polynomial distribution, and the like. The implementation of at least one of the first probability distribution, the second probability distribution, or the third probability distribution is not limited in the embodiments of the disclosure.

Optionally, the sampling method for sampling at least one of the first probability distribution, the second probability distribution, or the third probability distribution includes one of: an inverse transform method, a rejection sampling, an importance sampling, a Markov Monte Carlo sampling method, or the like. Alternatively, the sampling method for sampling at least one of the first probability distribution, the second probability distribution, or the third probability distribution may be any of the methods in the related art.

Optionally, sampling methods for sampling different probability distributions among the first probability distribution, the second probability distribution, and the third probability distribution may be the same or different. Exemplary, the first probability distribution sampling, the second probability distribution sampling, and the third probability distribution sampling all use the same sampling method. Further exemplary, the sampling methods for sampling the first probability distribution and the second probability distribution are the same, and the sampling methods for sampling the second probability distribution and the third probability distribution are different.

Optionally, in other embodiments, the first probability distribution of the hidden variable may be referred to as a first probability distribution of a hidden variable in a hidden space or a first probability distribution in a first hidden space or a hidden space. Optionally, in other embodiments, the second probability distribution of the hidden variable may be referred to as a second probability distribution of a hidden variable in a hidden space or a second probability distribution in a second hidden space or a hidden space. Optionally, in other embodiments, the third probability distribution of the hidden variable may be referred to as a third probability distribution of a hidden variable in a hidden space or a third probability distribution in a third hidden space or a hidden space.

Optionally, the first sampling result may be stored in the electronic apparatus in advance. When acquiring the set parameter information, the electronic apparatus may input the first sampling result and the set parameter information into the trained decoder. Optionally, the first probability distribution may be stored in the electronic apparatus in advance. When acquiring the set parameter information, the electronic apparatus may sample the first probability distribution to obtain a first sampling result, and input the first sampling result and the set parameter information into the trained decoder.

In the embodiments of the disclosure, a first sampling result and set parameter information are input into a trained first decoder, such that the trained first decoder outputs first channel information corresponding to the set parameter information.

The first sampling result is determined by sampling a first probability distribution of a hidden variable output by a trained first encoder. In this way, the trained first decoder may output the first channel information corresponding to the set parameter information based on the input set parameter information, without requiring manual effort to collect the set parameter information and the first channel information corresponding to the set parameter information, thereby improving the efficiency of obtaining the set parameter information and the first channel information corresponding to the set parameter information.

In some embodiments, the parameter information includes at least one of: distance information between a signal sending device and a signal receiving device, angle information between the signal sending device and the signal receiving device, or coordinate information of the signal sending device relative to the signal receiving device.

Optionally, the electronic apparatus may be the signal sending device or the signal receiving device, or the electronic apparatus may be included in the signal sending device or the signal receiving device. Optionally, the signal sending device and the signal receiving device may exist independently of the electronic apparatus. For example, the electronic apparatus is neither included in the signal sending device nor in the signal receiving device.

Optionally, the distance information between the signal sending device and the signal receiving device may include at least one of: straight-line distance information between the signal sending device and the signal receiving device, distance information relative to the x-axis between the signal sending device and the signal receiving device, distance information relative to the y-axis between the signal sending device and the signal receiving device, and distance information relative to the z-axis between the signal sending device and the signal receiving device.

Optionally, in any of embodiments of the disclosure, at least one of the x-axis, the y-axis, or the z-axis may be predefined. Optionally, origin position of the coordinate system corresponding to at least one of the x-axis, the y-axis, or the z-axis may be position of the signal receiving device, or position of the signal sending device, or another predefined position.

Optionally, the angle information may include at least one of: an angle of arrival (AOA), an angle of departure(AOD), angle information relative to the x-axis between the signal sending device and the signal receiving device, angle information relative to the y-axis between the signal sending device and the signal receiving device, or angle information relative to the z-axis between the signal sending device and the signal receiving device.

Optionally, the coordinate information may include at least one of: latitude and longitude coordinate information, one-dimensional coordinate information, two-dimensional coordinate information, or three-dimensional coordinate information.

Optionally, in any of embodiments of the disclosure, the contents included in different pieces of parameter information may be the same or different or partially the same.

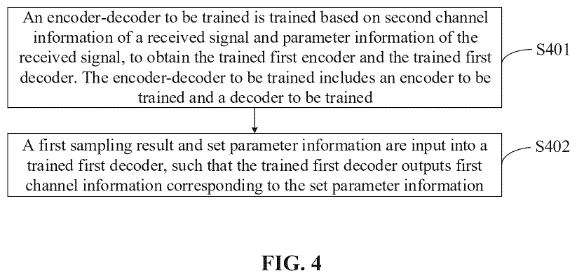

FIG. 4 is a schematic flowchart of another method for channel information determination provided in an embodiment of the disclosure. As illustrated in FIG. 4, the method is applied in an electronic apparatus and includes the following operation.

In operation S401, an encoder-decoder to be trained is trained based on second channel information of a received signal and parameter information of the received signal, to obtain the trained first encoder and the trained first decoder. The encoder-decoder to be trained includes an encoder to be trained and a decoder to be trained.

The first probability distribution is output by the trained first encoder when the second channel information and the parameter information of the received signal are input into the trained first encoder.

Optionally, in any of embodiments of the disclosure, the parameter information of the received signal may include parameter information corresponding to the received signal.

Optionally, the second channel information of the received signal and the parameter information of the received signal may be obtained in a test environment. Alternatively, the second channel information of the received signal and the parameter information of the received signal may be obtained in an actual scene. Optionally, the second channel information of the received signal and the parameter information of the received signal may be input by the user into the electronic apparatus, and/or may be sent by the signal receiving device to the electronic apparatus, and/or may be determined by the electronic apparatus itself as the signal receiving device.

Optionally, the parameter information of the received signal may include one or more pieces of parameter information of the received signal. Optionally, the second channel information of the received signal may include one or more pieces of second channel information of the received signal that corresponds one-to-one with one or more pieces of parameter information. Optionally, different pieces of parameter information correspond to different pieces of second channel information.

Optionally, the parameter information of the received signal may be determined by at least one relative position information between each signal sending device among the one or more signal sending devices and each signal receiving device among the one or more signal receiving devices in the environment. Optionally, N pieces of relative position information between each signal sending device and each signal receiving device determines N pieces of parameter information of the received signal, wherein N is an integer greater than or equal to 1. Optionally, the amount of parameter information of the received signal may be N×M×P, where N is the amount of relative position information between each signal sending device and each signal receiving device, M is the number of signal sending devices, and N is the number of signal receiving devices. Therefore, by increasing one or more signal sending device, and/or increasing one or more signal receiving device, and/or increasing relative position information between the signal sending device and the signal receiving device, it is possible to increase the amount of reference information of the received signal obtained.

Optionally, the signal receiving device may determine each piece of second channel information of the received signal corresponding to each piece of parameter information of the received signal based on any of the methods in the related art.

Optionally, the operation that the encoder-decoder to be trained is trained based on the second channel information of the received signal and the parameter information of the received signal may include that the second channel information of the received signal and the parameter information of the received signal are input into the encoder-decoder to be trained. The second channel information of the received signal and the parameter information of the received signal are used to train the encoder-decoder to be trained.

Optionally, after the training of the encoder-decoder to be trained is completed, the trained first encoder and the trained first decoder are obtained. The electronic apparatus may input the second channel information and the parameter information of the received signal into the trained first encoder, for the trained first encoder to output the first probability distribution.

Optionally, the electronic apparatus may store the first probability distribution. Alternatively, the electronic apparatus may sample the first probability distribution to obtain a first sampling result, and store the first sampling result.

Optionally, the process of training the encoder-decoder to be trained is a process in which the parameters in the encoder-decoder to be trained are continuously iterated. When the trained first encoder and the trained first decoder are obtained, the parameters in the trained first encoder may be first target parameters, and the parameters in the trained first decoder may be second target parameters.

In operation S402, a first sampling result and set parameter information are input into a trained first decoder, such that the trained first decoder outputs first channel information corresponding to the set parameter information.

The first sampling result is determined by sampling a first probability distribution of a hidden variable output by a trained first encoder.

In an embodiment of the disclosure, a solution of training an encoder-decoder to be trained is provided, so that the trained first encoder and the trained first decoder can be easily obtained.

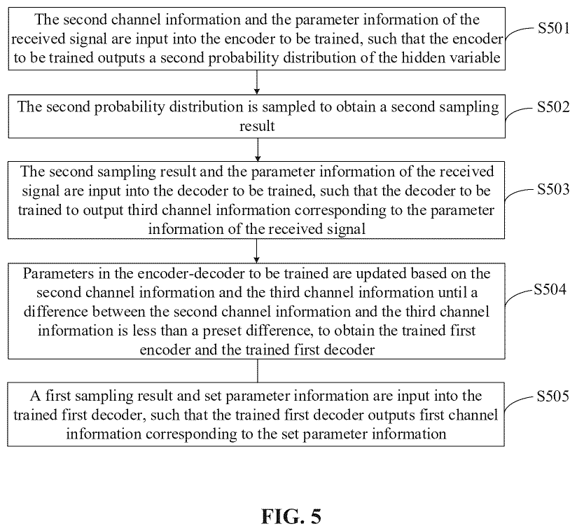

FIG. 5 is a schematic flowchart of yet another method for channel information determination provided in an embodiment of the disclosure. As illustrated in FIG. 5, the method is applied in an electronic apparatus. In the disclosure, the operation S401 may include operation S501 to operation S504. The method includes the following operations.

In operation S501, the second channel information and the parameter information of the received signal are input into the encoder to be trained, such that the encoder to be trained outputs a second probability distribution of the hidden variable.

Optionally, the parameter in the encoder to be trained may be a first initial parameter. The encoder to be trained may determine a second probability distribution of the hidden variable based on the second channel information, the parameter information of the received signal, and the first initial parameter.

Optionally, the second channel information may be channel information after preprocessing. The channel information before preprocessing cannot be directly input into the encoder to be trained. The electronic apparatus may perform preprocessing on the channel information before preprocessing to obtain the channel information after preprocessing, that is, the second channel information.

Optionally, the parameter information of the received signal may be parameter information after the second preprocessing. Optionally, parameter information before the second preprocessing cannot be directly input into the encoder to be trained and/or the decoder to be trained. The electronic apparatus may perform preprocessing on the parameter information before the second preprocessing to obtain the parameter information after the second preprocessing, that is, the parameter information of the received signal.

In operation S502, the second probability distribution is sampled to obtain a second sampling result.

In operation S503, the second sampling result and the parameter information of the received signal are input into the decoder to be trained, such that the decoder to be trained to output third channel information corresponding to the parameter information of the received signal.

Optionally, the parameter in the decoder to be trained may be a second initial parameter. The decoder to be trained may determine the third channel information corresponding to the parameter information of the received signal based on the second sampling result, the parameter information of the received signal, and the second initial parameter.

Optionally, the parameter information of the received signal may include one or more pieces of parameter information of the received signal. Optionally, the third channel information corresponding to the parameter information of the received signal may include one or more pieces of third channel information that corresponds one-to-one with one or more pieces of parameter information of the received signal. Optionally, different pieces of parameter information of the received signal correspond to different pieces of third channel information.

Optionally, the third channel information may also be referred to as reconstructed data in other embodiments.

In operation S504, parameters in the encoder-decoder to be trained are updated based on the second channel information and the third channel information until a difference between the second channel information and the third channel information is less than a preset difference, to obtain the trained first encoder and the trained first decoder.

Optionally, the electronic apparatus may iterate the parameters of the encoder and the parameters of the decoder based on the optimization goal of the encoder-decoder to be trained, or based on preset iteration strategy. For example, through the i-th iteration, the parameters of the encoder to be trained are first specific parameters of the i-th iteration, the parameters of the decoder to be trained are second specific parameters of the i-th iteration, and i is an integer greater than or equal to 1.

Optionally, in a case where the iterations of the parameters of the encoder to be trained and the parameters of the decoder to be trained are completed each time, the electronic apparatus may input the second channel information and the parameter information of the received signal into the encoder to be trained corresponding to the second specific parameter of the i-th iteration, so that the encoder to be trained corresponding to the second specific parameter of the i-th iteration outputs the probability distribution corresponding to the i-th iteration. The electronic apparatus samples the probability distribution corresponding to the i-th iteration to obtain a sampling result corresponding to the i-th iteration. The electronic apparatus may input the sampling result corresponding to the i-th iteration and the parameter information of the received signal into the decoder to be trained, so that the decoder to be trained outputs third channel information corresponding to the i-th iteration that corresponds the parameter information of the received signal. Optionally, in a case where a difference between the second channel information and the third channel information corresponding to the i-th iteration is greater than or equal to a preset difference, the iteration proceeds to the next round in the above manner until the difference between the second channel information and the third channel information of the last iteration is less than the preset difference, so that the training of the encoder to be trained and the decoder to be trained is completed, thereby obtaining the trained first encoder and the trained first decoder. Optionally, the first target parameter in the trained first encoder may be a first specific parameter of the last iteration, and the second target parameter in the trained first decoder may be a second specific parameter of the last iteration.

In operation S505, a first sampling result and set parameter information are input into the trained first decoder, such that the trained first decoder outputs first channel information corresponding to the set parameter information.

The first sampling result is determined by sampling a first probability distribution of a hidden variable output by a trained first encoder.

In some embodiments, the optimization goal of the encoder-decoder to be trained is to maximize an evidence lower bound (ELBO).

Optionally, ELBO may be determined based on q(z|x, y) and p(x|z, y).

Optionally, ELBO=−D_{KL}(q(z|x,y)∥p(z|y)+E_{q}(z|x,y)[log (p(x|z, y))].

Where x represents the second channel information of the received signal, y represents the parameter information of the received signal, and z represents the hidden variable.

q( ) represents a posterior distribution, and p( ) represents a prior distribution.

q( ) is associated with q, p( ) is associated with θ, and φ and θ are parameters in an encoder-decoder.

D_{KL}(q(z|x, y)∥p(z|y)) represents a KL divergence between q(z|x, y) and p(z|y).

E_{q}(z|x,y) [log (p(x|z, y))] represents a mathematical expectation of log (p(x|z, y)) with respect to the posterior distribution q(z|x, y).

Optionally, q(z|x, y) represents the probability of z when x, y occurs, p(x|z, y) represents the probability of x when z, y occurs, and p(z|y) represents the probability of z when y occurs.

Optionally, in other embodiments, there may be other formulas for ELBO, which is not limited in the embodiments of the disclosure.

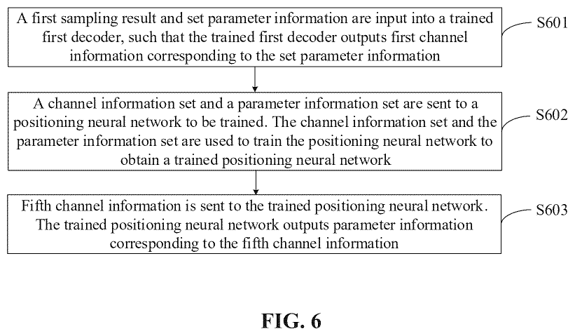

FIG. 6 is a schematic flowchart of still yet another method for channel information determination provided in an embodiment of the disclosure. As illustrated in FIG. 6, the method is applied in an electronic apparatus. It is to be noted that although the method in the embodiment corresponding to FIG. 6 includes operations S601 to S603, the methods in other embodiments may include operations S601 to S602. The operations S601 to S603 are as follows.

In operation S601, a first sampling result and set parameter information are input into a trained first decoder, such that the trained first decoder outputs first channel information corresponding to the set parameter information.

The first sampling result is determined by sampling a first probability distribution of a hidden variable output by a trained first encoder.

In operation S602, a channel information set and a parameter information set are sent to a positioning neural network to be trained. The channel information set and the parameter information set are used to train the positioning neural network to obtain a trained positioning neural network.

The channel information set includes the first channel information and second channel information of a received signal. The parameter information set includes the set parameter information and parameter information of the received signal.

Optionally, the positioning neural network to be trained may be stored in the electronic apparatus. Optionally, the positioning neural network to be trained may be sent from the first device to the electronic apparatus.

Optionally, the positioning neural network may be one of: a deep neural network, a convolutional neural network, or the like. The implementation of the positioning neural networks is not limited in the embodiments of the disclosure.

Optionally, in other embodiments, each piece of channel information in the channel information set may be preprocessed to obtain the information after preprocessing. The information set after preprocessing and the parameter information set may be sent to the positioning neural network to be trained. The information set after preprocessing and the parameter information set may be used to train the positioning neural network to obtain the trained positioning neural network.

Optionally, the operation that each piece of channel information in the information set after preprocessing is preprocessed may include that amplitude information and phase information corresponding to each piece of channel information in the information set after preprocessing are determined. Each piece of channel information after preprocessing in the information set after preprocessing is the amplitude information and the phase information corresponding to each piece of channel information.

Optionally, the electronic apparatus may send the trained positioning neural network to the first device, for the first device to use the trained positioning neural network. Optionally, the electronic apparatus may store the trained positioning neural network locally, for the electronic apparatus to use the trained positioning neural network.

In the embodiment of the disclosure, through the operation S602, the positioning neural network may be trained based on a large amount of channel information and parameter information corresponding to each piece of channel information, so that a large amount of training samples may be used to train the positioning neural network, and thus the training accuracy of the positioning neural network is improved.

Optionally, the method for channel information determination in some embodiments includes operation S601 and operation S602, while the method for channel information determination in other embodiments includes operation S601, operation S602, and operation S603.

In operation S603, fifth channel information is sent to the trained positioning neural network. The trained positioning neural network outputs parameter information corresponding to the fifth channel information.

Optionally, the fifth channel information may include one or more channel information, and each piece of channel information in the fifth channel information corresponds to a piece of parameter information. Optionally, different pieces of channel information in the fifth channel information correspond to different pieces of parameter information.

Optionally, the fifth channel information may be fifth channel information of the received signal that is currently received. Alternatively, the fifth channel information may be sent by the third device to the electronic apparatus. Optionally, the electronic apparatus may send parameter information corresponding to the fifth channel information to the third device.

In the embodiment of the disclosure, through the operation S603, the electronic apparatus may determine the parameter information corresponding to the fifth channel information based on the trained positioning neural network, so that the electronic apparatus may determine the relative position information between the signal sending device and the signal receiving device based on the fifth channel information, which is beneficial to improve the efficiency and accuracy of determining the relative position information.

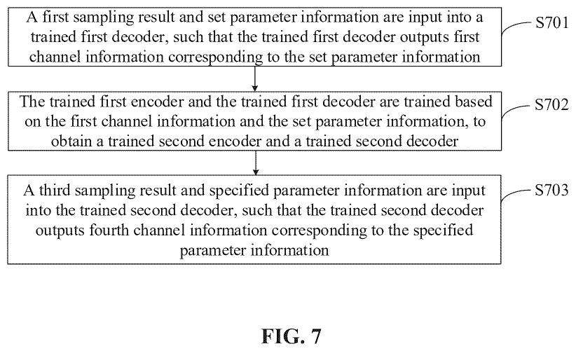

FIG. 7 is a schematic flowchart of a method for channel information determination provided in another embodiment of the disclosure. As illustrated in FIG. 7, the method is applied in an electronic apparatus and includes the following operations.

In operation S701, a first sampling result and set parameter information are input into a trained first decoder, such that the trained first decoder outputs first channel information corresponding to the set parameter information.

The first sampling result is determined by sampling a first probability distribution of a hidden variable output by a trained first encoder.

In operation S702, the trained first encoder and the trained first decoder are trained based on the first channel information and the set parameter information, to obtain a trained second encoder and a trained second decoder.

Optionally, the training method corresponding to training the trained first encoder and the trained first decoder based on the first channel information and the set parameter information may be the same as the training method corresponding to training the encoder-decoder to be trained based on the second channel information of the received signal and the parameter information of the received signal, and the specific implementation process may be referred to each other.

In operation S703, a third sampling result and specified parameter information are input into the trained second decoder, such that the trained second decoder outputs fourth channel information corresponding to the specified parameter information.

The third sampling result is determined by sampling a third probability distribution of the hidden variable output by the trained second encoder.

Optionally, the embodiment corresponding to inputting the third sampling result and the specified parameter information into the trained second decoder for the trained second decoder to output the fourth channel information corresponding to the specified parameter information may be the same as the embodiment corresponding to inputting the first sampling result and the set parameter information into the trained first decoder, for the trained first decoder to output the first channel information corresponding to the set parameter information.

In an embodiment of the disclosure, and the trained first encoder and the trained first decoder are trained based on the first channel information and the set parameter information, so that in a case where the first channel information corresponding to the set parameter information is obtained by using the trained first decoder, the trained first encoder and the trained first decoder may be continuously trained again by using the first channel information and the set parameter information. In this way, the encoder and the decoder may increasingly align with the actual situation.

In any of embodiments in the disclosure, the received signal includes at least one of: a channel state information reference signal (CSI-RS), a demodulation reference signal (DMRS), a synchronization signal block (SSB), a phase tracking reference signal (PTRS), a sounding reference signal (SRS), a sidelink reference signal, an ultra wide band (UWB) signal, a wireless fidelity (Wi-Fi) signal, a Bluetooth signal, or a Zigbee signal. Herein, the SSB may also be referred to as a synchronization signal/physical broadcast channel block (SS/PBCH block). Optionally, in other embodiments, the received signal may include a reference signal other than the signals listed above.

In any of embodiments in the disclosure, at least one of the first channel information, the second channel information, the third channel information, the fourth channel information, or the fifth channel information includes at least one of: channel state information (CSI), channel information of a ultra wide band (UWB) signal, channel information of a wireless fidelity (Wi-Fi) signal, channel information of a Bluetooth signal, or channel information of a Zigbee signal.

Exemplary, in a case where each of the first channel information, the second channel information, the third channel information, the fourth channel information, and the fifth channel information includes a CSI, the first channel information may be a first CSI, the second channel information may be a second CSI, the third channel information may be a third CSI, the fourth channel information may be a fourth CSI, and the fifth channel information may be a fifth CSI.

In some embodiments, the first sampling result and the trained first decoder are determined locally by an electronic apparatus or sent by a first device. For example, the first sampling result and the trained first decoder may be sent from the first device to the electronic apparatus.

In some embodiments, the method further includes that the set parameter information is received from a second device, and/or the first channel information is sent to the second device. In this way, the second device may obtain the first channel information corresponding to the set parameter information through the electronic apparatus in the absence of the trained first decoder and/or the first sampling result, thereby avoiding a situation in which the second device cannot obtain the first channel information corresponding to the set parameter.

Optionally, the second device may include the positioning neural network, so that the second device may train the positioning neural network based on the channel information set and the parameter information set.

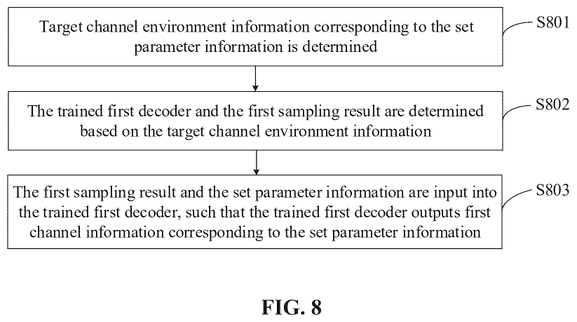

FIG. 8 is a schematic flowchart of a method for channel information determination provided in yet another embodiment of the disclosure. As illustrated in FIG. 8, the method is applied in an electronic apparatus and includes the following operations.

In operation S801, target channel environment information corresponding to the set parameter information is determined.

Optionally, the target channel environment information may be indicated by one or more values.

Optionally, the target channel environment information corresponding to the set parameter information may be determined by at least one of the following methods. The target channel environment information is input by the user to the electronic apparatus. The target channel environment information is determined based on position information input by the user to the electronic apparatus. The target channel environment information is determined by the electronic apparatus based on the position of the signal sending device and/or the position of the signal receiving device. The target channel environment information is determined by the electronic apparatus based on the moving speed of the signal sending device and/or the moving speed of the signal receiving device. The target channel environment information is determined by the electronic apparatus based on the distance between the signal sending device and the signal receiving device. The target channel environment information is determined by the electronic apparatus based on the signal type of the received signal. Exemplary, any two signals listed above differ in signal types. For example, the signal types of any two signals, such as CSI-RS, DMRS, UWB signal, and Wi-Fi signal, are different.

Optionally, in some embodiments, the target channel environment information may include at least one of: a channel type, a channel parameter, or the like. Optionally, in some embodiments, the channel type may include, but is not limited to, one or more of: an ideal channel, a natural channel, or an artificial channel. Optionally, in other embodiments, the channel type may include, but is not limited to, one or more of: a channel type corresponding to 4G communication, a channel type corresponding to 5G communication, a channel type corresponding to 6G communication, a channel type corresponding to sidelink communication, a channel type corresponding to UWB communication, a channel type corresponding to Wi-Fi communication, a channel type corresponding to Bluetooth communication, a channel type corresponding to Zigbee communication, or the like. Optionally, the channel parameter may include at least one of: a signal noise ratio (SNR), a moving speed of the signal sending device and/or a moving speed of the signal receiving device, a time offset, a frequency offset, a downlink received interference signal strength, a modulation mode, or the like.

Optionally, in other embodiments, the target channel environment information may include at least one of: a median of mean path loss, a large-scale shadow fading factor, a large-scale path loss index, a small-scale multipath fading coefficient, or the like.

Exemplary, in areas with a high density of terminal devices, the corresponding target channel environment information is relatively poor, whereas in areas with a low density of terminal devices, the corresponding target channel environment information is relatively good. Further exemplary, the target channel environment at the edge of the cell corresponding to the network device is relatively poor, while the target channel environment at the center of the cell corresponding to the network device is relatively good.

In operation S802, the trained first decoder and the first sampling result are determined based on the target channel environment information.

Optionally, the operation S802 may include that based on the target channel environment information, a first trained decoder is determined from the multiple trained decoders, and a first sampling result is determined from the multiple sampling results. Optionally, the following three items correspond one-to-one: multiple target channel environment information entries, multiple trained decoders, and multiple sampling results.

Optionally, the electronic apparatus may store the one-to-one correspondence relationships between multiple target channel environment information, multiple trained decoders, and multiple sampling results.

For example, there is a correspondence relationship between the channel environment information 1, the trained decoder 1, and the sampling result 1. There is a correspondence relationship between the channel environment information 2, the trained decoder 2, and the sampling result 2. There is a correspondence relationship between the channel environment information 3, the trained decoder 3, and the sampling result 3. In a case where the target channel environment information is the channel environment information 3, the trained first decoder and the first sampling result are determined to be the trained decoder 3 and the sampling result 3, respectively.

In operation S803, the first sampling result and the set parameter information are input into the trained first decoder, such that the trained first decoder outputs first channel information corresponding to the set parameter information.

The first sampling result is determined by sampling a first probability distribution of a hidden variable output by a trained first encoder.

In the embodiment of the disclosure, the trained first decoder and the first sampling result are determined based on the target channel environment information, so that different pieces of channel environment information correspond to different trained decoders and different sampling results. Therefore, the trained first decoder and the first sampling result corresponding to the target channel environment information may be determined, the first channel information corresponding to the set parameter information may be determined, thereby improving the accuracy of the determined first channel information corresponding to the set parameter information.

Some implementations of the embodiment of the disclosure are described below.

The disclosure considers the data collection for wireless communication systems in indoor and/or outdoor scenarios (corresponding to the test environment). The transmitting terminal (corresponding to the aforementioned signal sending device) sends wireless signal (corresponding to the aforementioned received signal), which are then received by the receiving terminal (corresponding to the aforementioned signal receiving device). The receiving terminal preprocesses the received signal to obtain the collected data. Through the method in the embodiments of the disclosure, data enhancement is conducted based on the collected data to obtain a complete data set for subsequent training of a positioning estimation model (corresponding to the aforementioned positioning neural network).

Exemplary, data collection may be conducted at M positions within the indoor environment (that is, M relative positions between the signal sending device and the signal receiving device) to obtain a complete data set that may be used for positioning estimation. For example, data collection is conducted at Mₐ positions, and the collected data set Φₐ is obtained. M_{b} positions where data collection is not conducted are recorded as uncollected data set Φ_{b}, that is, the relationship of formula (1) is satisfied.

$$M = {M}_{a} + {M}_{b} ; \qquad ( 1 )$$

The sets of the collected data set and the uncollected data set are defined as follows. The collected data set is {1, 2, . . . , Mₐ}N_{c}={1, 2, . . . , N} N_{c}={1, 2, . . . , N}. The uncollected data set is {Mₐ+1, Mₐ+2, . . . , Mₐ+M_{b}}. The coordinate of position k is pₖ=[xₖ,yₖ]^{T}. The parameter vector containing all collected positions is

$${P}_{a} = {[ {p}_{1}^{T} , {p}_{2}^{T} , ... , {p}_{{M}_{a}}^{T} ]}^{T} ,$$

while the parameter vector of the uncollected positions is

$${P}_{b} = {[ {p}_{1}^{T} , {p}_{2}^{T} , … , {p}_{{M}_{b}}^{T} ]}^{T} ,$$

Taking the application of angle measurement as an example, assuming that the receiving terminal is always at the coordinate origin, the angle θₖ from the transmitting terminal k at the collection position to the receiving terminal in the standard coordinate system is defined as the angular parameter, which is represented by formula (2).

$${θ}_{k} = arc tan ( \frac{{x}_{k}}{{y}_{k}} ) ; \qquad ( 2 )$$

Where xₖ is a distance relative to the x-axis between the signal sending device and the signal receiving device, and yₖ is a distance relative to the y-axis between the signal sending device and the signal receiving device.

Optionally, the disclosure may be further applied to the application scenario of distance measurement and the hybrid application scenario of ranging and angle measurement.

The signal received by the receiving terminal at a specified collection location k is represented by formula (3).

$${r}_{k} ( t ) = {\sum }_{l = 1}^{L} {α}_{k}^{( l )} {s}_{j} ( t - {τ}_{k}^{( l )} ) + n ( t ) ; \qquad ( 3 )$$

Where sⱼ(t) is a known signal (corresponding to a signal sent by the aforementioned signal sending device), L is the number of multipaths, 1={1,2, . . . , L} is an indication of different propagation paths of the signal,

$${α}_{k}^{( l )} and {τ}_{k}^{( l )}$$

are the amplitude and time-delay, respectively, corresponding to the signal of the l-th propagation path, and n(t) is Gaussian white noise.

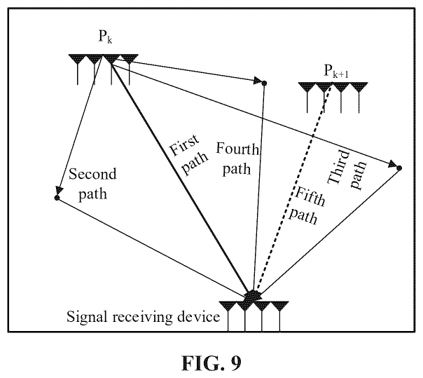

FIG. 9 is a schematic diagram of sending and receiving of a signal provided in an embodiment of the disclosure. As illustrated in FIG. 9, the signal sending device Pₖ may send the reference signal to the signal receiving device through the first path, or send the reference signal to the signal receiving device through the second path, the third path, or the fourth path. Herein, the first path may be a direct connection path between the signal sending device Pₖ and the signal receiving device. The second path, the third path, and the fourth path are scattering paths between the signal sending device Pₖ and the signal receiving device. The signal sending device Pₖ₊₁ may send the reference signal to the signal receiving device through the fifth path. Herein, the fifth path may be a direct connection path between the signal sending device Pₖ₊₁ and the signal receiving device.

In some embodiments, channel state information (CSI) of the wireless channel may be obtained based on the received signal. For example, the CSI may be represented by formula (4).

$${H}_{i , m , n}^{( k )} = {\sum }_{l = 1}^{L} {γ}_{l} {e}^{- j 2 π ( i - 1 ) Δ f {τ}_{l}} {e}^{- j π ( m - 1 ) sin {φ}_{l}} {e}^{- j π ( n - 1 ) sin {θ}_{l}} ; \qquad ( 4 )$$

Where L is the number of multipaths, 1={1,2, . . . , L} is an indication of the different propagation paths of the signal, γ₁ and τ₁ are the amplitude and time-delay, respectively, corresponding to the signal of the l-th propagation path, Δf is the subcarrier spacing configured by the system, φ₁ and θ₁ are the angle of departure(AoD) and the angle of arrival (AoA), respectively, i, m, n correspond to the i-th subcarrier, the m-th antenna element in the transmitting array, and the n-th antenna element in the receiving array, respectively, and

$${H}_{i , m , n}^{( k )}$$

is the CSI corresponding to the k-th position.

In some embodiments, the collected data set Φₐ and the uncollected data set Φ_{b} may be represented by formula (5) and formula (6), respectively.

$${Φ}_{a} = \{ ( {H}^{( 1 )} , {θ}_{1} ) , ( {H}^{( 2 )} , {θ}_{2} ) , … , ( {H}^{( {M}_{a} )} , {θ}_{{M}_{a}} ) \} ; \qquad ( 5 )$$

$${Φ}_{b} = \{ ( {H}^{( {M}_{a} + 1 )} , {θ}_{{M}_{a} + 1} ) , ( {H}^{( {M}_{a} + 2 )} , {θ}_{{M}_{a} + 2} ) , … , ( {H}^{( {M}_{a} + {M}_{b} )} , {θ}_{{M}_{a} + {M}_{b}} ) \} ; \qquad ( 6 )$$

Where, H^{(k)} represents CSI corresponding to the k-th position, k may be 1, 2 until Mₐ+M_{b}, and θₖ represents angle information corresponding to the k-th position.

In some embodiments, environmental information is extracted from the CSI (corresponding to the second channel information of the received signal) of the collected data based on the data-enhanced conditional variational learning algorithm, environmental feature (corresponding to the second sampling results) in the test environment is obtained. The CSI with specified labels is generated based on the obtained environmental feature and a given labeled angle(corresponding to the parameter information of the received signal). Therefore, the enhancement of wireless signal data for indoor environment positioning is implemented, thereby achieving the objective of reducing the amount of data required for positioning.

The dimension of CSI as a feature in the collected data set is relatively high, and the transformation relationship from the environmental feature to the CSI is relatively complex. Therefore, we consider combining deep learning technology and variational Bayesian inference to estimate the unknown distribution in a data-driven manner by accumulating knowledge from the data. The reasoning process of the data-enhanced conditional variational learning algorithm is described below.

First, fake data is generated in combination with specified labels. However, it is difficult to obtain the distribution directly. Therefore, in the disclosure, the signal generation process is modeled as a Bayesian model containing hidden variable based on the variational Bayesian inference, in which the hidden variable corresponds to the environmental feature. The sample feature is denoted as x (corresponding to the second channel information of the received signal), the corresponding angle label is y (corresponding to the parameter information of the received signal), and the hidden variable is z. The derivation process of the optimization objective of the encoder-decoder to be trained is as follows.

The objective function L may be determined by formula (7) and formula (8).

$$L = log ( p ( x \vert y ) ) ; \qquad ( 7 )$$

$$L = {\sum }_{Z} q ( z \vert x , y ) log ( \frac{p ( z , x \vert y )}{q ( z \vert x , y )} ) + {D}_{KL} ( q ( z \vert x , y ) \vert \vert p ( z \vert x , y ) ) ; \qquad ( 8 )$$

Where D_{KL}(·∥·) is a Kullback-Leibler (KL) divergence between distributions. To ensure that the constructed variational distribution q(z|x, y) is as similar as possible to p(z, x|y), it is necessary to minimize the KL divergence between them. Due to p(x|y) is fixed, i.e., L is a fixed constant, if the KL divergence is to be minimized, the evidence variational lower bound should be maximized. That is to say, the ELBO in formula (9) should be maximized.

$$ELBO = {\sum }_{Z} q ( z \vert x , y ) log ( \frac{p ( z , x \vert y )}{q ( z \vert x , y )} ) ; \qquad ( 9 )$$

From formula (9), we can derive formula (10).

$$ELBO = {\sum }_{Z} q ( z \vert x , y ) log ( \frac{p ( z , x \vert y ) p ( z \vert y )}{q ( z \vert x , y )} ) ; \qquad ( 10 )$$

From formula (10), we can derive formula (11).

$$ELBO = {\sum }_{Z} q ( z \vert x , y ) log ( \frac{p ( z \vert y )}{q ( z \vert x , y )} ) + {\sum }_{Z} q ( z \vert x , y ) log ( p ( x \vert z , y ) ) ; \qquad ( 11 )$$

From formula (11), we can derive formula (12).

$$ELBO = - {D}_{KL} ( q ( z \vert x , y ) \vert \vert p ( z \vert y ) ) + {E}_{q ( z \vert x , y )} [ log ( p ( x \vert z , y ) ) ] ; \qquad ( 12 )$$

Thus, the optimal variational estimation for searching the variational distribution q(z|x, y) may be performed based on the variational lower bound. The optimal variational estimation q* may be obtained by solving the optimization problem in the following formula (13).

$${q}^{*} = arg {max}_{q ∈ Q} ELBO ; \qquad ( 13 )$$

Where Q represents probability distribution set.

Considering that the dimension of CSI as a feature in the collected data set is relatively high and the transformation relationship from the environmental feature to the CSI is relatively complex, the fitting is performed by combining deep learning technology. The encoder-decoder architecture is adopted, which functions to encode input CSI data (corresponding to the second channel information of the received signal) in combination with condition information (corresponding to the parameter information of the received signal) into a hidden variables, and reconstruct signals from the hidden variable and the condition information. During the training process, the inputs of the encoder are the collected CSI data and angle labels as condition information (corresponding to the parameter information of the received signal), and the encoder performs information fusion and encoding on the CSI data and the condition information to obtain the corresponding hidden variable, that is, the fitting of z=e_{σ}(x, y) (it may be z=e(x, y) or z=e(x) in other embodiments) is completed. The input of the decoder is the hidden variable output by the encoder and the corresponding condition information, and the data is reconstructed by the decoder to obtain the reconstructed data, that is, the fitting of x=d_{ϕ}(z, y) (it may be \hat{x}=d(z, y) or \hat{x}=d(z) in other embodiments) is completed, where σ, φ are network parameters, and the parameters of the model are updated based on the reconstruction error. During the generation process, only the decoder part is used. The inputs of the decoder (corresponding to the trained first decoder) are the specified angle labels as condition information and the hidden variable(corresponding to the first sampling result) sampled in the hidden space. The CSI data corresponding to the angle labels is generated by the decoder. That is to say, the data (corresponding to the first channel information) is generated based on \hat{x}=d_{ϕ}(z, y) obtained through training in combination with the angle labels.

In summary, the disclosure has implemented an algorithm that adaptively extracts reliable features of high-dimensional data based on the collected data CSI and corresponding labels and obtains corresponding fake data (corresponding to the first channel information). The algorithm primarily consists of an encoder that outputs environmental features from signal CSI data and a decoder that outputs reconstructed signal CSI data or generates signal CSI data from environmental features.

During the training stage of the algorithm, the encoder performs information fusion and encoding based on the input collected CSI data and the angle labels as the conditional information, to obtain the corresponding hidden variables, and the fitting of z=e_{σ}(x, y) is completed. The decoder reconstructs the data to obtain the reconstructed data based on the input hidden variables output by the encoder and the corresponding condition information, and the fitting of \hat{x}=d_{q}(z, y) is completed.

During the generation stage of the algorithm, only the decoder part is used. The inputs are the specified angle labels as the conditional information and the hidden variables sampled in the hidden space, and the CSI data corresponding to the angle labels is generated by the decoder.

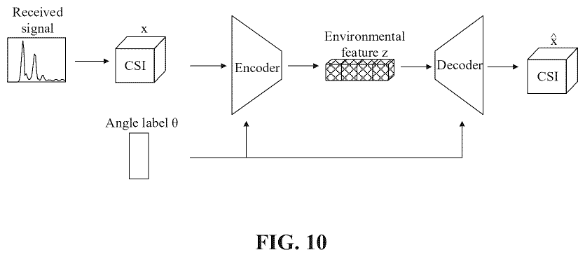

FIG. 10 is a schematic diagram of the training process of an encoder-decoder to be trained provided in an embodiment of the disclosure. As illustrated in FIG. 10, the encoder and the decoder in FIG. 10 are the encoder-decoder to be trained. After the training is completed, the trained encoder-decoder is obtained. First, the received signal is obtained; the second channel information CSI (also referred to as x) of the received signal is determined based on the received signal; the parameter information (also referred to as γ or angle label θ) of the received signal corresponding to the second channel information CSI of the received signal is determined; the second channel information CSI of the received signal and the parameter information of the received signal are input into the encoder to be trained, to output the environmental feature z through the encoder to be trained; the environmental feature z and the parameter information of the received signal (also referred to as y or angle label θ) are input into into the decoder to be trained, and the decoder outputs third channel information CSI (also referred to as \hat{x}) corresponding to the parameter information of the received signal. Then, by using the difference between x and \hat{x}, the parameters in the encoder-decoder to be trained are iterated until the difference between \hat{x} output by the decoder and x meets the requirement (e.g., is smaller than a preset difference).

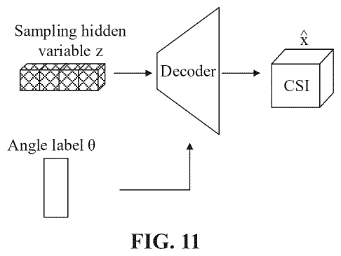

FIG. 11 is a schematic diagram of the generation process of first channel information provided in an embodiment of the disclosure. As illustrated in FIG. 11, the decoder in FIG. 11 may be a trained first decoder. A first sampling result (for example, a sampling hidden variable z) and set parameter information (also referred to as y or angle label θ) are input to the trained first decoder, then the trained first decoder outputs first channel information CSI (also referred to as R) corresponding to the set parameter information.

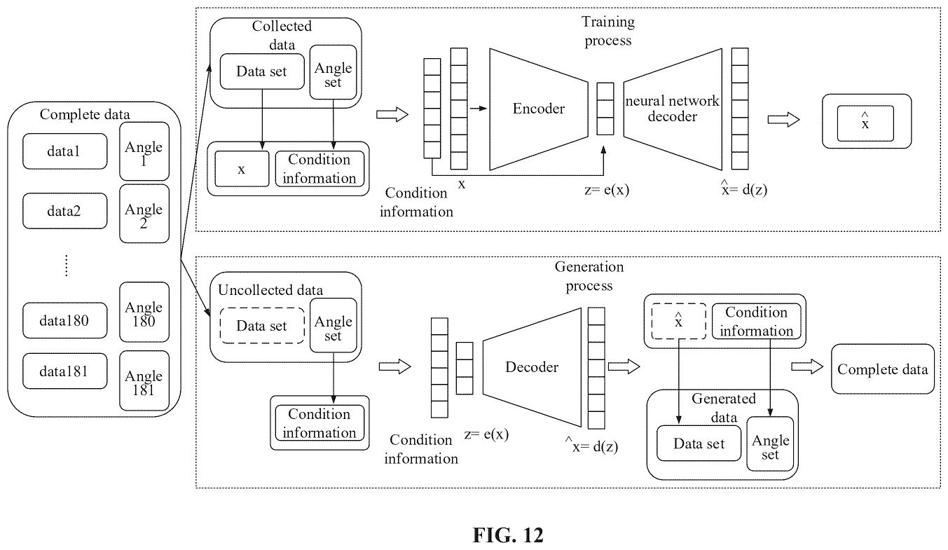

FIG. 12 is a schematic diagram of a system architecture provided in an embodiment of the disclosure. As illustrated in FIG. 12, complete data may be obtained firstly. The complete data includes a data set and an angle set. The data set includes multiple data, and each data may be a CSI. The angle set includes multiple angles, and multiple data may correspond one-to-one with multiple angles. For example, in the embodiment corresponding to FIG. 12, the multiple data includes data1, data2, . . . , data180, and data181, and the multiple angles include angle 1, angle 2, . . . , angle 180, and angle 181.

Then, the complete data may be taken as the collected data, and x and condition information may be determined based on the data set and the angle set in the collected data. Among them, x is determined based on the data set, and the condition information is determined based on the angle set. Exemplary, the data set may be preprocessed to determine x that may be input into the encoder. Exemplary, the angle set may be preprocessed to determine the condition information that may be input into the encoder and decoder.

Thus, in a case where x and the condition information are obtained, x and the condition information may be input into the encoder, so that the encoder outputs the probability distribution of z(z=e(x)). Then, the probability distribution of the z may be sampled to obtain the sampling result z, and the sampling result z and the condition information are input into the decoder, so that the decoder outputs \hat{x}(\hat{x}=d(z)). Thereby, by using the difference between x and \hat{x}, the parameters in the encoder-decoder to be trained are iterated until the difference between \hat{x} output by the decoder and x meets the requirement (e.g., is smaller than a preset difference), so that the trained first encoder and the trained first decoder are obtained.

After the training of the encoder-decoder to be trained is completed, the first channel information corresponding to the set parameter information may be generated by using the trained first decoder. The generation process of the first channel information will be described below.

The angle set in the uncollected data is obtained. The angle set in the uncollected data may be an angle set other than the angle set in the complete data, and the objective of the generation process is to obtain the data set in the uncollected data.

First, the condition information is determined based on the angle set in the uncollected data. Exemplary, the angle set in the uncollected data may be preprocessed to determine the condition information that may be input into the decoder.

Then, the condition information and the sampling result z(z=e(x)) may be input into the decoder (which is understood as the trained first decoder), so that the decoder outputs \hat{x} (\hat{x}=d(z)). Next, R and the condition information may be preprocessed, respectively. The data set and the angle set in the uncollected data are obtained and then added to the complete data.

In the embodiments of the disclosure, due to the adoption of deep learning method, it includes the training stage and the generation stage. During the training stage, the deep neural network is trained based on the collected data set obtained in advance to obtain the network model. During the generation stage, the trained network model is utilized to generate the required data by combining the required label information with the hidden variables sampled in the hidden space.

The main purpose of the training stage(preprocessing stage) of the system is to build the database and train the deep neural network. The main processes are as follows.

(1) A measurement system is established, and data collection was conducted at Mₐ positions where experimental testing is required. The received signals at corresponding positions, along with label information (corresponding to parameter information of the received signal) for the current position, are obtained to construct a collected data set Φₐ.

(2) Based on the collected data set Φₐ constructed in the operation (1), a training set and a validation set are obtained, and then the designed deep learning model is trained, and the model is validated based on the validation set. The inputs of the model are the CSI data of the collected signal and the condition information, and the output of the model is the CSI data of the reconstructed signal.

(3) The parameters of the model are updated based on the reconstruction error between the CSI data of the reconstructed signal and the CSI data of the input signal. The network parameters are iteratively updated in a loop until the training converges.

The main purpose of the generation stage(actual usage stage) of the system is to realize the generation of data with specified labels and complete data enhancement based on the network parameters and the specified labels. The main processes are as follows. M_{b} positions where data collection is required but experimental testing has not been conducted are selected; the labeled portion of the uncollected data set Øp is obtained; taking the labeled portion as conditional information and combining it with the hidden variables sampled in the hidden space as inputs, the network model from the training phase is utilized to generate fake data with the specified labels.

In view of the problems that the current positioning method based on deep learning needs to collect a large amount of accurately labeled data, the establishment of the data set is difficult and the labor cost is high, and if the amount of data collected is insufficient, it will affect positioning accuracy, a solution for the enhancement of wireless signal data for indoor environment positioning is proposed in the disclosure, aiming to reduce the amount of data required for positioning and lower the cost of the establishment of the data set. The measured air interface data contains rich environmental information. In this solution, the signal generation process is modeled as a Bayesian model containing hidden variable based on the received signal and variational Bayesian inference, in which the hidden variable corresponds to the characteristics of the test environment; a deep learning neural network is designed to adaptively extracts reliable features of high-dimensional data; and corresponding fake data is generated based on specified labels. Therefore, the enhancement of wireless signal data for indoor environment positioning is implemented, thereby achieving the objective of reducing the amount of data required for positioning.

First of all, in view of the complex data processing of current data enhancement methods and the need to estimate fake labels (corresponding to the first channel information), this solution designs a data enhancement algorithm based on variational Bayesian inference and deep learning technology. The environment feature is learned based on the collected data, and label information (including the second channel information of the received signal and the parameter information of the received signal) are incorporates into network input and hidden variables, so as to achieve the purpose of generating data with specified labels (corresponding to the first channel information). This ultimately enables the generation of data with specified labels under relatively low data processing complexity.

Secondly, this solution integrates deep generative networks with hidden variable models for data enhancement in indoor and/or outdoor positioning algorithms. The deep learning methods may make full use of data. Compared with traditional machine learning methods, the deep learning methods are more suitable for processing high-dimensional raw data, adaptively extracting reliable features of high-dimensional data, and are more suitable for processing signals in complex indoor environments. By adding hidden variables, the signal generation process is modeled as a Bayesian model containing hidden variables. Data enhancement can be carried out by reflecting environmental features through hidden variables, thus improving the robustness of data enhancement.

Finally, the designed algorithm is validated through simulation experiments and public data sets. Aiming at the complex indoor multipath environment, we use the collected data to learn the environmental features, and fake data is generated by combining the label information. The experimental indicate a significant reduction in the reconstruction error of the generated data, demonstrating that the algorithm proposed in this solution can achieve the purpose of generating fake data with corresponding labels. Therefore, this scheme is beneficial to ensuring the performance of high-precision positioning.

The solution of the data enhancement system proposed in the present technical solution exhibits universality in applicable wireless signal types. The signal types include, but are not limited to, 5G signals, cellular signals, Wi-Fi signals, and the like.

The solution of the data enhancement system proposed in the present solution is mainly aimed at the application of angle measurement in the above. But in fact, the system also exhibits universality for positioning parameters, that is, the application of distance measurement or the application of distance and angle measurement simultaneously can be implemented. The specific technical difference lies in the corresponding modification of the standard information of the data set and the corresponding modification of the input interface of the model.

The preferred implementations of the disclosure have been described in detail as above with reference to the accompanying drawings. However, the disclosure is not limited to the specific details in the above implementations. Within the scope of the technical concept of the disclosure, various simple modifications may be made to the technical solutions of the disclosure, and all these simple modifications belong to the scope of protection of the disclosure. For example, various specific technical features described in the above specific implementations may be combined in any suitable manner without contradiction. In order to avoid unnecessary repetition, various possible combinations will not be described any more in the disclosure. For another example, various different implementations of the disclosure may also be combined arbitrarily, as long as they do not depart from the idea of the disclosure, which should also be considered as the contents disclosed in the disclosure. For another example, provided that there is no conflict, the embodiments and/or technical features within the embodiments described in the disclosure may be arbitrarily combined with related art. The technical solutions obtained after the combination should also fall within the scope of protection of the disclosure.

It should further be understood that, in various method embodiments of the disclosure, the values of the sequence numbers of the aforementioned processes do not imply the sequence of execution. The sequence of execution of the processes should be determined based on functions thereof and inherent logics, and the values of the sequence numbers should not constitute any limitation on the implementation processes of the embodiments of the disclosure. Furthermore, in the embodiments of the disclosure, the terms “downlink”, “uplink” and “sidelink” are used to represent a transmission direction of a signal or data. Herein, the “downlink” is used to represent that the transmission direction of the signal or data is a first direction sent from a station to a user equipment of a cell; the “uplink” is used to represent that the transmission direction of the signal or data is a second direction sent from the user equipment of the cell to the station; and the “sidelink” is used to represent that the transmission direction of the signal or data is a third direction sent from a user equipment 1 to a user equipment 2. For example, a “downlink signal” represents that the signal is transmitted in the first direction. In addition, in the embodiments of the disclosure, the term “and/or” merely indicates an association relationship for describing associated objects, and represents that there are three kinds of relationships. Specifically, “A and/or B” may represent three situations, i.e., independent existence of A, existence of both A and B, and independent existence of B. In addition, in this context, the character “/” generally indicates that the anterior and posterior associated objects are in a kind of “or” relationship.

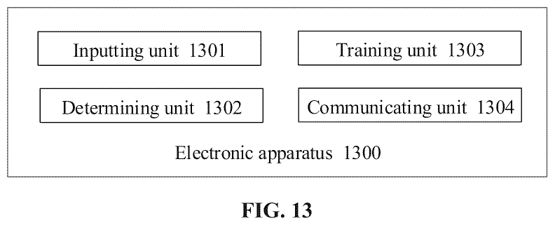

FIG. 13 is a schematic diagram of a compositional structure of an electronic apparatus provided in an embodiment of the disclosure. As illustrated in FIG. 13, the electronic apparatus 1300 includes an inputting unit 1301.

The inputting unit 1301 is configured to input a first sampling result and set parameter information into a trained first decoder, such that the trained first decoder outputs first channel information corresponding to the set parameter information.

The first sampling result is determined by sampling a first probability distribution of a hidden variable output by a trained first encoder.

Optionally, the electronic apparatus 1300 further includes a determining unit 1302. The determining unit 1302 is configured to determine the first sampling result and the set parameter information.

Optionally, the parameter information includes at least one of: distance information between a signal sending device and a signal receiving device, angle information between the signal sending device and the signal receiving device, or coordinate information of the signal sending device relative to the signal receiving device.

Optionally, the electronic apparatus 1300 further includes a training unit 1303.

The training unit 1303 is configured to train an encoder-decoder to be trained based on second channel information of a received signal and parameter information of the received signal, to obtain the trained first encoder and the trained first decoder. The encoder-decoder to be trained includes an encoder to be trained and a decoder to be trained.

The first probability distribution is output by the trained first encoder when the second channel information and the parameter information of the received signal are input into the trained first encoder.

Optionally, the training unit 1303 is further configured to input the second channel information and the parameter information of the received signal into the encoder to be trained, such that the encoder to be trained outputs a second probability distribution of the hidden variable.

The training unit 1303 is further configured to sample the second probability distribution to obtain a second sampling result.

The training unit 1303 is further configured to input the second sampling result and the parameter information of the received signal into the decoder to be trained, such that the decoder to be trained to output third channel information corresponding to the parameter information of the received signal.

The training unit 1303 is further configured to update parameters in the encoder-decoder to be trained based on the second channel information and the third channel information until a difference between the second channel information and the third channel information is less than a preset difference, to obtain the trained first encoder and the trained first decoder.

Optionally, an optimization objective of the encoder-decoder to be trained is to maximize an evidence lower bound (ELBO);

$$ELBO = - {D}_{KL} ( q ( z \vert x , y ) \vert \vert p ( z \vert y ) ) + {E}_{q ( z \vert x , y )} [ log ( p ( x \vert z , y ) ) ] ;$$

Where x represents the second channel information of the received signal, y represents the parameter information of the received signal, and z represents the hidden variable.

q( ) represents a posterior distribution, and p( ) represents a prior distribution.

q( ) is associated with q, p( ) is associated with θ, and φ and θ are parameters in an encoder-decoder.

D_{KL}(q(z|x, y)∥p(z|y)) represents a KL divergence between q(z|x, y) and p(z|y).

E_{q}(z|x,y) [log (p(x|z,y))] represents a mathematical expectation of log (p(x|z, y)) with respect to the posterior distribution q(z|x, y).

Optionally, the inputting unit 1301 is further configured to send a channel information set and a parameter information set to a positioning neural network to be trained. The channel information set and the parameter information set are used to train the positioning neural network to obtain a trained positioning neural network.

The channel information set includes the first channel information and second channel information of a received signal. The parameter information set includes the set parameter information and parameter information of the received signal.

Optionally, the inputting unit 1301 is further configured to send fifth channel information to the trained positioning neural network. The trained positioning neural network outputs parameter information corresponding to the fifth channel information.

Optionally, the training unit 1303 is further configured to train the trained first encoder and the trained first decoder based on the first channel information and the set parameter information, to obtain a trained second encoder and a trained second decoder.

The inputting unit 1301 is further configured to input a third sampling result and specified parameter information into the trained second decoder, such that the trained second decoder outputs fourth channel information corresponding to the specified parameter information.

The third sampling result is determined by sampling a third probability distribution of the hidden variable output by the trained second encoder.

Optionally, the received signal includes at least one of: channel state information reference signal (CSI-RS), demodulation reference signal (DMRS), synchronization signal block (SSB), phase tracking reference signal (PTRS), sounding reference signal (SRS), sidelink reference signal, ultra wide band (UWB) signal, wireless fidelity (Wi-Fi) signal, Bluetooth signal, or Zigbee signal.

Optionally, at least one of the first channel information, the second channel information, the third channel information, the fourth channel information, or the fifth channel information includes at least one of: channel state information (CSI), channel information of a ultra wide band (UWB) signal, channel information of a wireless fidelity (Wi-Fi) signal, channel information of a Bluetooth signal, or channel information of a Zigbee signal.

Optionally, the first sampling result and the trained first decoder are determined locally by an electronic apparatus or sent by a first device.

Optionally, the electronic apparatus 1300 further includes a communicating unit 1304. The communicating unit 1304 is configured to receive the set parameter information from a second device, and/or send the first channel information to the second device.

Optionally, the determining unit 1302 is further configured to determine target channel environment information corresponding to the set parameter information. The determining unit 1302 is further configured to determine the trained first decoder and the first sampling result based on the target channel environment information.

In the embodiments of the disclosure, a first sampling result and set parameter information are input into a trained first decoder, such that the trained first decoder outputs first channel information corresponding to the set parameter information. The first sampling result is determined by sampling a first probability distribution of a hidden variable output by a trained first encoder. In this way, the trained first decoder may output the first channel information corresponding to the set parameter information based on the input set parameter information, without requiring manual effort to collect the set parameter information and the first channel information corresponding to the set parameter information, thereby improving the efficiency of obtaining the set parameter information and the first channel information corresponding to the set parameter information.

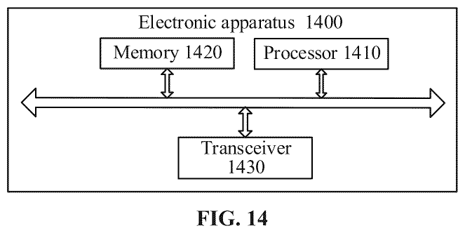

FIG. 14 is a schematic diagram of a compositional structure of another electronic apparatus provided in an embodiment of the disclosure. The electronic apparatus 1400 illustrated in FIG. 14 may include a processor 1410 and a memory 1420. The memory 1420 is used for storing a computer program. The processor 1410 is configured to call and run the computer program stored in the memory 1420, to cause the electronic apparatus 1400 to perform the method in any of the above embodiments.

Optionally, the memory 1420 may be a separate device independent of the processor 1410, or may be integrated in the processor 1410.

Optionally, the as illustrated in FIG. 14, the electronic apparatus 1400 may further include a transceiver 1430, and the processor 1410 may control the transceiver 1430 to communicate with other devices. Specifically, the transceiver may transmit information or data to other devices, or receive information or data from other devices.

The transceiver 1430 may include a transmitter and a receiver. The transceiver 1430 may further include one or more antennas.

The embodiment of the disclosure further provides a computer storage medium storing one or more programs. The one or more programs are executable by one or more processors to implement the method for channel information determination in any of embodiments of the disclosure.

In some embodiments, the computer-readable storage medium may be applied to the electronic apparatus in the embodiments of the disclosure, and the computer program causes the computer to execute corresponding processes implemented by the electronic apparatus in each of the methods in the embodiments of the disclosure. For brevity, details will not be repeated herein again.

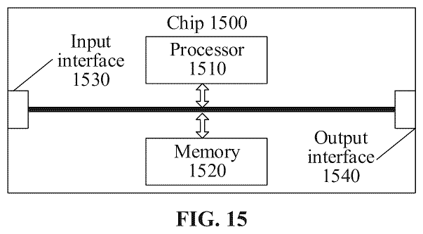

FIG. 15 is a schematic structural diagram of a chip according to an embodiment of the disclosure. The chip 1500 illustrated in FIG. 15 includes a processor 1510 that configured to call and run a computer program from a memory to implement the method in any of the embodiments of the disclosure.

In some embodiments, as illustrated in FIG. 15, the chip 1500 may further include a memory 1520. The processor 1510 may call and run a computer program from the memory 1520 to implement each of the methods in the embodiments of the disclosure.

The memory 1520 may be a separate device independent of the processor 1510, or may be integrated in the processor 1510.

In some embodiments, the chip 1500 may further include an input interface 1530. The processor 1510 may control the input interface 1530 to communicate with other devices or chips. Specifically, the input interface 1530 may acquire information or data from other devices or chips.

In some embodiments, the chip 1500 may further include an output interface 1540. The processor 1510 may control the output interface 1540 to communicate with other devices or chips. Specifically, the output interface 1540 may output information or data to other devices or chips.

In some embodiments, the chip may be applied to the electronic apparatus in the embodiments of the disclosure, and the chip may implement corresponding processes implemented by the electronic apparatus in each of the methods in the embodiments of the disclosure. For brevity, details will not be repeated herein again.

It should be understood that the chip mentioned in the embodiments of the disclosure may also be referred to as a system-level chip, a system chip, a chip system, or a system-on-chip, etc.

The embodiment of the disclosure further provides a computer program product. The computer program product includes a computer storage medium storing a computer program. The computer program includes instructions executable by at least one processor that, when executed by the at least one processor, implement the method for channel information determination in any of embodiments of the disclosure.

In some embodiments, the computer program product may be applied to the electronic apparatus in the embodiments of the disclosure, and the computer program instructions cause the computer to execute corresponding processes implemented by the electronic apparatus in each of the methods in the embodiments of the disclosure. For brevity, details will not be repeated herein again.

Optionally, a computer program product in the embodiment of the disclosure may also be referred to as a software product in other embodiments.

The embodiment of the disclosure further provides a computer program that causes a computer to perform the method for channel information determination in any of embodiments of the disclosure.

In some embodiments, the computer program may be applied to the electronic apparatus in the embodiments of the disclosure. The computer program, when executed by a computer, causes the computer to execute corresponding processes implemented by the electronic apparatus in each of the methods in the embodiments of the disclosure. For brevity, details will not be repeated herein again.

The processor, the electronic apparatus or the chip may be an integrated circuit chip with a signal processing capability. In an implementation process, various operations of the aforementioned method embodiments may be completed by an integrated logic circuit of hardware in the processor or the instructions in the form of software. The processor, the electronic apparatus or the chip described above may include any one of or an integration of more of: a general purpose processor, an application specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), an embedded neural-network processing unit (NPU), TPU, DPU, BPU, a controller, a microcontroller, a microprocessor, a programmable logic device, discrete gates or transistor logic devices, a discrete hardware component. Various methods, operations and logic block diagrams disclosed in the embodiments of the disclosure may be implemented or performed. The general-purpose processor may be a microprocessor, or may be any conventional processor or the like. The operations of the methods disclosed in the embodiments of the disclosure may be directly embodied to be executed and completed by a hardware decoding processor, or by a combination of hardware and software modules in the decoding processor. The software module may be located in a mature storage medium in the field, such as a random access memory (RAM), a flash memory, a read-only memory (ROM), a programmable ROM (PROM), or an electrically erasable programmable memory, a register, etc. The storage medium is located in the memory, and the processor reads information in the memory and completes the operations of the foregoing method in combination with its hardware.

It is understood that the memory or the computer storage medium in the embodiments of the disclosure may be a volatile memory or a non-volatile memory, or include both a volatile and a non-volatile memory. The non-volatile memory may be a ROM, a PROM, an erasable PROM (EPROM), an electrically EPROM (EEPROM), or a flash memory. The volatile memory may be a RAM, which serves as an external high-speed cache. It is exemplarily but unlimitedly described that RAMs in various forms may be adopted, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DRRAM). It is to be noted that the memories of the systems and methods described herein is intended to include, but not limited to, memories of these and any other suitable types.

It is to be understood that the aforementioned memory or computer storage medium is described only exemplarily rather than limitedly. For example, the memory in the embodiments of the disclosure may further be an SRAM, a DRAM, an SDRAM, a DDR SDRAM, an ESDRAM, an SLDRAM and a DR RAM, etc. That is to say, the memory in the embodiments of the disclosure is intended to include, but not limited to, memories of these and any other suitable types.

Those of ordinary skilled in the art may appreciate that the units and algorithmic operations of each of the examples described in the embodiments disclosed herein may be implemented in electronic hardware, or a combination of computer software and electronic hardware. Whether these functions are performed in hardware or software depends on the specific application and design constraints of the technical solutions. The professionals may use different methods to implement the described functions for each specific application, and such implementations shall not be considered as going beyond the scope of the disclosure.

Those skilled in the art may clearly understand that, for the specific working processes of the systems, devices, and units described above, reference may be made to the corresponding processes in the aforementioned method embodiments, which will not be repeated herein for convenience and conciseness of the description.

In several embodiments provided in the disclosure, it is to be understood that the disclosed systems, devices, and methods may be implemented in other ways. For example, the device embodiments described above are only schematic. For example, the partition of the unit is only a kind of logical functional partition, and other partition manners may be adopted during practical implementation. For example, multiple units or components may be combined or integrated into another system, or some features may be omitted or not implemented. In addition, coupling or direct coupling or communication connection between various displayed or discussed components may be indirect coupling or communication connection, implemented through some interfaces, devices or units, and may be an electrical or mechanical connection or in other forms.

The units described as separate components may or may not be physically separate, and the components displayed as units may or may not be physical units, that is, may be located in one place or be distributed to multiple network units. Part or all of the units may be selected based on the actual needs to achieve the purpose of the solution of the present embodiment.

In addition, various functional units in the embodiments of the disclosure may be integrated into one processing unit, or they may be physically exist separately as individual units, or two or more units may be integrated into one unit.

The functions may be stored in a computer readable storage medium if implemented in the form of software functional units and sold or used as a stand-alone product. Based on such understanding, the essential part of the technical solutions of the disclosure or a part of the technical solutions that contributes to the related art or the part of the technical solutions may be embodied in a form of a software product. The software product is stored in a storage medium and includes instructions which cause a computer device (which may be a personal computer, a server, or a network device, etc.) to perform all or part of the operations in the methods described in various embodiments of the disclosure. The foregoing storage medium includes various media capable of storing program codes, such as a USB disk, a mobile hard disk, a ROM, a RAM, a magnetic disk, an optical disk, or the like.

The foregoing are only the specific implementations of the disclosure; however, the scope of protection of the disclosure is not limited thereto. Variations or replacements which can be readily conceived by those skilled in the art within the technical scope disclosed by the disclosure shall fall within the scope of protection of the disclosure. Therefore, the scope of protection of the disclosure shall be subject to the scope of protection of the claims.

1. A method for channel information determination, comprising:
inputting a first sampling result and set parameter information into a trained first decoder, such that the trained first decoder outputs first channel information corresponding to the set parameter information;
wherein the first sampling result is determined by sampling a first probability distribution of a hidden variable output by a trained first encoder.

2. The method of claim 1, wherein the set parameter information comprises at least one of: distance information between a signal sending device and a signal receiving device, angle information between the signal sending device and the signal receiving device, or coordinate information of the signal sending device relative to the signal receiving device.

3. The method of claim 1, further comprising:
training an encoder-decoder to be trained based on second channel information of a received signal and parameter information of the received signal, to obtain the trained first encoder and the trained first decoder, wherein the encoder-decoder to be trained comprises: an encoder to be trained and a decoder to be trained;
wherein the first probability distribution is output by the trained first encoder when the second channel information and the parameter information of the received signal are input into the trained first encoder.

4. The method of claim 3, wherein training the encoder-decoder to be trained based on the second channel information of the received signal and the parameter information of the received signal to obtain the trained first encoder and the trained first decoder comprises:
inputting the second channel information and the parameter information of the received signal into the encoder to be trained, such that the encoder to be trained outputs a second probability distribution of the hidden variable;
sampling the second probability distribution to obtain a second sampling result;
inputting the second sampling result and the parameter information of the received signal into the decoder to be trained, such that the decoder to be trained to output third channel information corresponding to the parameter information of the received signal; and
updating parameters in the encoder-decoder to be trained based on the second channel information and the third channel information until a difference between the second channel information and the third channel information is less than a preset difference, to obtain the trained first encoder and the trained first decoder.

5. The method of claim 3, wherein an optimization objective of the encoder-decoder to be trained is to maximize an evidence lower bound (ELBO);
$$ELBO = - {D}_{KL} ( q ( z \vert x , y ) \vert \vert p ( z \vert y ) ) + {E}_{q ( z \vert x , y )} [ log ( p ( x \vert z , y ) ) ] ;$$
where x represents the second channel information of the received signal, y represents the parameter information of the received signal, and z represents the hidden variable;
q( ) represents a posterior distribution, and p( ) represents a prior distribution;
q( ) is associated with q, p( ) is associated with θ, and φ and θ are parameters in the encoder-decoder;
D_{KL}(q(z|x,y)∥p(z|y)) represents a KL divergence between q(z|x, y) and p(z|y);
and E_{q}(z|x,y) [log (p(x|z, y))] represents a mathematical expectation of log (p(x|z,y)) with respect to the posterior distribution q(z|x, y).

6. The method of claim 1, further comprising:
sending a channel information set and a parameter information set to a positioning neural network to be trained, wherein the channel information set and the parameter information set are used to train the positioning neural network to obtain a trained positioning neural network;
wherein the channel information set comprises the first channel information, and second channel information of a received signal; and the parameter information set comprises the set parameter information, and parameter information of the received signal.

7. The method of claim 6, further comprising:
sending fifth channel information to the trained positioning neural network, wherein the trained positioning neural network outputs parameter information corresponding to the fifth channel information.

8. The method of claim 1, further comprising:
training the trained first encoder and the trained first decoder based on the first channel information and the set parameter information, to obtain a trained second encoder and a trained second decoder; and
inputting a third sampling result and specified parameter information into the trained second decoder, such that the trained second decoder outputs fourth channel information corresponding to the specified parameter information;
wherein the third sampling result is determined by sampling a third probability distribution of the hidden variable output by the trained second encoder.

9. The method of claim 3, wherein the received signal comprises at least one of: channel state information reference signal (CSI-RS), demodulation reference signal (DMRS), synchronization signal block (SSB), phase tracking reference signal (PTRS), sounding reference signal (SRS), sidelink reference signal, ultra wide band (UWB) signal, wireless fidelity (Wi-Fi) signal, Bluetooth signal, or Zigbee signal.

10. The method of claim 1, wherein at least one of the first channel information, the second channel information, the third channel information, the fourth channel information, or the fifth channel information comprises at least one of: channel state information (CSI), channel information of a ultra wide band (UWB) signal, channel information of a wireless fidelity (Wi-Fi) signal, channel information of a Bluetooth signal, or channel information of a Zigbee signal.

11. The method of claim 1, wherein the first sampling result and the trained first decoder are determined locally by an electronic apparatus or sent by a first device; and/or
the method further comprises: receiving the set parameter information from a second device, and/or sending the first channel information to the second device.

12. The method of claim 1, further comprising:
determining target channel environment information corresponding to the set parameter information; and
determining the trained first decoder and the first sampling result based on the target channel environment information.

13. An electronic apparatus, comprising: a processor and a memory,
the memory is used to store a computer program, and
the processor is configured to invoke and run the computer program stored in the memory to cause the electronic apparatus to perform a method, the method comprising:
inputting a first sampling result and set parameter information into a trained first decoder, such that the trained first decoder outputs first channel information corresponding to the set parameter information;
wherein the first sampling result is determined by sampling a first probability distribution of a hidden variable output by a trained first encoder.

14. The electronic apparatus of claim 13, wherein the set parameter information comprises at least one of: distance information between a signal sending device and a signal receiving device, angle information between the signal sending device and the signal receiving device, or coordinate information of the signal sending device relative to the signal receiving device.

15. The electronic apparatus of claim 13, wherein the processor is further configured to invoke and run the computer program stored in the memory to cause the electronic apparatus to perform an operation of:
training an encoder-decoder to be trained based on second channel information of a received signal and parameter information of the received signal, to obtain the trained first encoder and the trained first decoder, wherein the encoder-decoder to be trained comprises: an encoder to be trained and a decoder to be trained;
wherein the first probability distribution is output by the trained first encoder when the second channel information and the parameter information of the received signal are input into the trained first encoder.

16. The electronic apparatus of claim 15, wherein training the encoder-decoder to be trained based on the second channel information of the received signal and the parameter information of the received signal to obtain the trained first encoder and the trained first decoder comprises:
inputting the second channel information and the parameter information of the received signal into the encoder to be trained, such that the encoder to be trained outputs a second probability distribution of the hidden variable;
sampling the second probability distribution to obtain a second sampling result;
inputting the second sampling result and the parameter information of the received signal into the decoder to be trained, such that the decoder to be trained to output third channel information corresponding to the parameter information of the received signal; and
updating parameters in the encoder-decoder to be trained based on the second channel information and the third channel information until a difference between the second channel information and the third channel information is less than a preset difference, to obtain the trained first encoder and the trained first decoder.

17. A non-transitory computer storage medium having stored thereon one or more programs that are executable by one or more processors to implement a method, the method comprising:
inputting a first sampling result and set parameter information into a trained first decoder, such that the trained first decoder outputs first channel information corresponding to the set parameter information;
wherein the first sampling result is determined by sampling a first probability distribution of a hidden variable output by a trained first encoder.

18. The storage medium of claim 17, wherein the set parameter information comprises at least one of: distance information between a signal sending device and a signal receiving device, angle information between the signal sending device and the signal receiving device, or coordinate information of the signal sending device relative to the signal receiving device.

19. The storage medium of claim 17, wherein the method further comprises:
training an encoder-decoder to be trained based on second channel information of a received signal and parameter information of the received signal, to obtain the trained first encoder and the trained first decoder, wherein the encoder-decoder to be trained comprises: an encoder to be trained and a decoder to be trained;
wherein the first probability distribution is output by the trained first encoder when the second channel information and the parameter information of the received signal are input into the trained first encoder.

20. The storage medium of claim 19, wherein training the encoder-decoder to be trained based on the second channel information of the received signal and the parameter information of the received signal to obtain the trained first encoder and the trained first decoder comprises:
inputting the second channel information and the parameter information of the received signal into the encoder to be trained, such that the encoder to be trained outputs a second probability distribution of the hidden variable;
sampling the second probability distribution to obtain a second sampling result;
inputting the second sampling result and the parameter information of the received signal into the decoder to be trained, such that the decoder to be trained to output third channel information corresponding to the parameter information of the received signal; and
updating parameters in the encoder-decoder to be trained based on the second channel information and the third channel information until a difference between the second channel information and the third channel information is less than a preset difference, to obtain the trained first encoder and the trained first decoder.
